(19) United States
(12) Patent Application Publication
(10) Pub. No.: US 2010/0065410 A1
(43) Pub. Date: Mar. 18, 2010

(54) HIGH TEMPERATURE SEPARABLE CONTINUOUS RESIDUE DISCHARGING SYSTEM AND METHOD OF USING THE SAME

(76) Inventor: Jianguo LI, Woodridge, IL (US)

Correspondence Address: LADAS & PARRY LLP, 224 SOUTH MICHIGAN AVENUE, SUITE 1600, CHICAGO, IL, 60604, US

(21) Appl. No.: 12/211,988

(22) Filed: Sep. 17, 2008

(51) Int. Cl. C10B 33/02; B08B 9/087; C10B 43/00

(52) U.S. Cl. 201/2; 202/241; 202/261

(57) ABSTRACT

Presented in this application is a simply operated, continuous residue discharging system. The system includes two sub-systems which convey residue from a reactor, through a closed residue discharging channel, to a residue storage tank. Also disclosed is a method of using the high temperature, separable, continuous residue discharging system and a kit including components for a continuous residue discharging system.

### FIELD OF THE INVENTION

The present invention relates to the recycling of plastic, and more particularly to a system and method for the removal of residue generated by converting waste plastics or into hydrocarbon oil.

### BACKGROUND OF THE INVENTION

With the rapid development of plastic industry, plastic articles are getting increasingly important in industrial production and more involved in every field of our daily life. With the abundance of new applications of plastics, more and more plastic waste is being created. Because the waste plastics are almost non-decompositionable in their natural condition, it has become a serious threat to the survival of our environment. As such, it is very important to solve the pollution problem in our environment caused by the waste plastics, and to get them recycled and utilized.

So far, various methods to treat waste plastics have been proposed. A method of treating waste plastics in disclosed in U.S. Pat. No. 4,851,601 and a method of rapidly converting waste plastics into a high quality oil is disclosed in JP-A-5-345894. However, when converting waste plastics into oil, residue is created as a byproduct. As the residue builds up in the vessels where the conversion reaction takes place, it must be cleaned. Conventional methods in the art involve shutting the vessel down, waiting a long period of time for the vessel to cool, and scraping off the residue. Problems associated with the conventional method are that the vessel needs to be shut down and allowed to cool for an extended period of time before it can be manually cleaned. Also, the manual discharging process is slow which leads to a decrease in the amount of production since the vessel must be stopped to discharge the residue. Moreover, even when using this method, it is extremely difficult to remove the thick sedimentary residue at the bottom of the reactor. Another disadvantage of the methods used in the prior art is that the residue comes into contact with the outside air causing pollution.

As such, there is a need in the art for a system and method that can be used to quickly and continuously remove the residue in a reaction vessel and significantly decrease the discharging time. Also, there is a need in the art for a system and method that can be used to effectively remove all of the thick sedimentary residue at the bottom of the reactor while decreasing the risk of fire and amount of air pollution associated with the current methods of discharging. Finally, there is a need to produce a system and method to allow for immediate discharging of the residue upon shutting down the vessel, while the vessel is still at or near operating temperature, instead of waiting for the vessel to cool.

### SUMMARY OF THE INVENTION

Accordingly, it is the intention of certain aspects of the present invention to develop a simply operated, all piping processing continuous residue discharging system to overcome the aforementioned disadvantages. During the discharging process, the residue does not come into contact with the air. Furthermore, certain aspects of the present invention are directed to an automatic, closed channel process, that does not emit any polution discharge.

Other advantages of the present invention are that the discharging process is accomplished in a short amount of time, it provides a safer environment for the operator of the reactor or the person who may otherwise face the task of cleaning the reactor and it improves the overall productivity as the reactor can focus more time performing its desired function and less time being off-line and cleaned. Moreover, it allows for immediate discharging of the residue, such as while the reactor is still at or near its operating temperature, which can be about 380° C. or higher or lower as desired, as opposed to waiting for the vessel to cool and then discharging the residue. Once the vessel has cooled, the sedimentary residue is extremely difficult to remove and thus, the lifetime of the reactor is cut short. In accordance with the present invention, the lifetime of the reactor is not shortened and actually lengthened as there is little or no build-up of sedimentary residue since the residue is discharged before it has had a chance to cool.

In a preferred embodiment there is provided a continuous residue discharging system including a first residue discharging system housed inside of a reactor. Also included is a curved tube protruding through a wail of said reactor having an outlet extending outward from the reactor and a flange on said outlet, which is connected to a first tube. The first tube, which can be retractable, is then connected to a second tube, which can be made of steel and have a 325 mm diameter. Finally, the second tube is further connected to a residue storage tank.

Furthermore, there is a second residue discharging system housed inside of the second tube. The combination of the curved tube, first tube and second tube form a closed residue discharging channel between the first residue discharging system and the second residue discharging system.

The first residue discharging system preferably includes a three shaft conveyor system. The three shaft conveyor system includes a driver shaft and a first and second driven shaft. The driver shaft and said first and second driven shafts are each supported by one or more sliding bearings. The driver shaft further includes a spiral vane disposed thereon and the first and second driven shafts each include a residue collecting vane disposed thereon. The driver shaft further includes a driver gear intertwined with a first gear of the first driven shaft and a second gear of the second driven shaft whereby rotation of the driver shaft thereby results in synchronized rotation of the first and second driven shafts. In certain embodiments, a first power source, through a clutch, delivers power to said driver shaft thereby causing it to rotate. One of the three shafts extends from inside of the reactor through the inside of the curve tube thereby pushing residue into the curved tube. In other embodiments, the first residue discharging system includes any number of shafts.

The second residue discharging system may include a single driver shaft conveyor system. This single driver shaft can be supported by one or more sliding bearings and can include a spiral vane disposed thereon. In other embodiments, the second residue discharging system includes any number of shafts. A second power source delivers power to the single driver shaft thereby causing it to rotate.

A method of discharging residue is also disclosed. In certain aspects of this method, a reactor is provided with a first residue discharging system housed therein. The first residue discharging system includes at least one driver shaft and the driver shaft includes a spiral vane disposed thereon. Next, a curved tube is provided which protrudes through a wall of the reactor and has an outlet extending outward from the reactor. The outlet gets connected to a first tube, which can be retractable, through a flange and the first tube gets connected to a second tube, which can be made of steel and have a 325 mm diameter. Finally, the second tube gets connected to a residue storage tank. A second residue discharging system is housed inside of the second tube. The combination of the curved tube, first tube and second tube form a closed residue discharging channel is between the first residue discharging system and the second residue discharging system. The second residue discharging system comprises at least a single driver shaft including a spiral vane disposed thereon. Upon activation of a first power source, the power source thereby, through a clutch, transfers power to the driver shaft which causes the shaft to rotate. A second power source is activated which thereby transfers power to the single driver shaft causing it to rotate as well. Do to the rotation of the shafts and the spiral vanes thereon, residue is conveyed from the reactor to the curved tube, then through the first tube to the second tube. Once in the second tube, the residue is conveyed by rotation of the single driver shaft and spiral vane disposed thereon from the second tube to the residue storage tank.

In the method described above a first and second driven shaft, each with a residue collecting vane disposed thereon, may be part of the first residue discharging system. A driver gear of the driver shaft is intertwined with a first gear of the first driven shaft and a second gear of the second driven shaft. Upon the transfer of power from the first power source, through said clutch, to the driver shaft, the driver shaft begins to rotate and through the intertwined driver, first and second gears, the first and second driven shafts begin to rotate as well.

The method can begin immediately or shortly thereafter the reactor is shut down and while it is still at or near its operating temperature, which may be about 380° C. or higher or lower as desired.

Also disclosed herein is continuous residue discharging system kit that includes a reactor; a first residue discharging system; a curved tube having an outlet with a flange thereon; a first tube; a second tube; a second residue discharging system; and a residue storage tank. Instructions may also be included in the kit for assembling the discharging system.

The preferred embodiments of the invention will now be described with reference to the accompanying drawing figures.

### BRIEF DESCRIPTION OF THE DRAWING FIGURES

FIG. 1 is a cross-sectional side view of a reactor incorporating the continuous residue discharging system of certain embodiments of the present invention.

FIG. 2 is a cross-sectional top view of a reactor incorporating certain embodiments of the first residue discharging system of the present invention.

### DETAILED DESCRIPTION

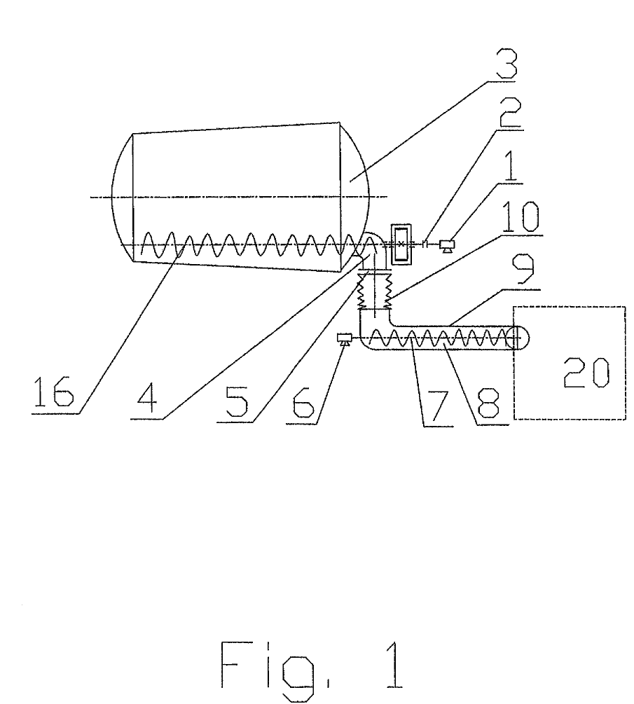

A preferred embodiment of the continuous residue discharging system according to certain aspects of the present invention will now be described. With respect to FIG. 1, a high temperature, separable, continuous residue discharging system includes two sub-systems; a first residue discharging system and a second residue discharging system. The first residue discharging system is assembled in a reactor 3. The reactor 3 can be any type of reactor that converts plastic, rubber, industrial waste or the like into oil, fuel, or the like. The first residue discharging system is a three unilateral shaft conveyer system. However, the system may include only one shaft or any number of shafts depending on the diameter of the shafts and the size of the reactor that the shafts are housed inside of. In the embodiment shown in FIG. 1, the driver shaft 16 of the conveyor system extends the length of the reactor 3 and further into a curved tube 4. A spiral vane 17 is disposed on the driver shaft 16.

The curved tube 4 includes a flange 5, which connects the curved tube 4 to a first tube 10. The first tube 10 has the ability to retract from the connection with the curved tube 4. Also shown is the first tube 10 as it connects to the second tube 9. In certain embodiments the second tube 9 is made of steel and has a diameter of 325 mm but this tube can be made from a variety of materials known in the art and include a large range of diameter sizes. Furthermore, the second tube 9 can be an integral, single body tube or it can comprise multiple segments that are connected together to form a pathway. The second tube 9 is further attached to a residue storage tank 20. The connection of the curved tube 4 by its flange 5 to the first tube 10, the first tube 10 to the second tube 9, and the second tube 9 to the residue storage tank 20 forms a closed residue discharging channel.

Housed inside of the second tube 9 is a second residue discharging system. As shown, the second residue discharging system includes a single driver shaft 7 with a spiral vane 8 disposed thereon. The spiral vane 8 can be located in between a pair of bearing components (not shown), which support the single driver shaft 7 and allow it to rotate smoothly. However, in other embodiments, the second residue discharging system can include any number of shafts.

Also depicted in FIG. 1 are the sources used to power the system. A first power source 1 delivers power, through a clutch 2, to the driver shaft 16 of the first residue discharging system. The second power source 6 is also shown. This power source delivers power to the single driver shaft 7 of the second residue discharging system. The power sources 1,6 can consist of an engine and a decelerator.

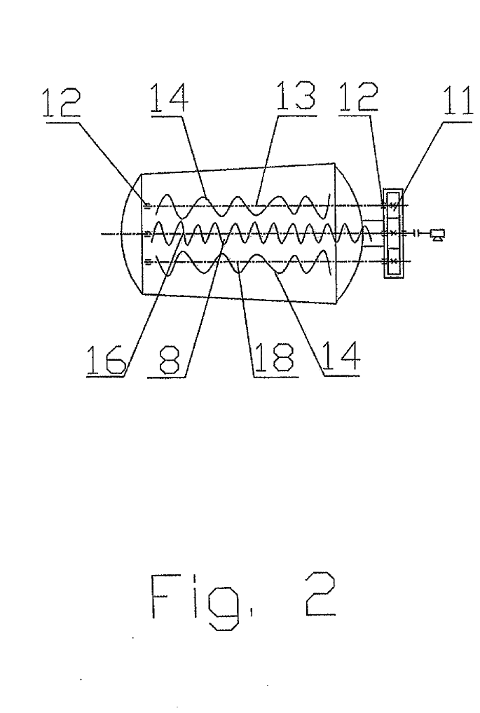

Turning now to FIG. 2, an embodiment of the first residue discharging system is displayed including a three unilateral shaft conveyor system housed in a reactor 3. The driver shaft 16 is shown as well as a first driven shaft 13 and a second driven shaft 18. The first and second driven shafts 13,18 include residue collecting vanes 14 disposed thereon. The driver shaft 16 includes a spiral vane 8 disposed thereon. These vanes 8,14 assist in the residue collection and conveying process. The shafts 13,16 of the first residue discharging system are supported at both of their ends by bearing components 12. The bearing components 12 allow for smooth rotation of each shaft 13,16. Also shown (but not labeled) is the curved tube 4 and the driver shaft 16 is extending therethrough. The driver shaft 16 includes a driver gear that is intertwined with a first gear of the first driven shaft and a second gear of the second driven shaft. All of these gears are housed inside of a gear case 11.

To utilize the aforementioned embodiments of the present invention, the first tube 10 is connected to the flange 5 on the curved tube 4. The first power source 1 is activated and transfers power, through the clutch 2, to the driver shaft 16. The second power source 6 is also activated and it transfers power to the single driver shaft 7. As power is transferred to these shafts 7,16 they begin to rotate. Rotation is smooth because the shafts 7,16 are supported on bearing components 12. As the driver shaft 16 begins to rotate, its driver gear rotates causing the first and second gears of the first and second driven shafts 13,18 to rotate, which in turn, causes the first and second driven shafts 13,18 to rotate. The residue collecting vanes 14 disposed on the first and second driven shafts 13,18 and the spiral vane 8 disposed on the driver shaft 16 collect residue from inside of the reactor 3 and as rotation of the vanes 8,14 occurs, residue is pushed or conveyed towards the curved tube 4. Since the driver shaft 16 and the spiral vane 8 disposed thereon extend through the curved tube 4, the residue is pushed into the curved tube and falls down, through the first tube 10 and into the second tube 9. Once the residue falls into the second tube 9, the spiral vane 8 on the rotating single driver shaft 7 begins to push or convey it towards the residue storage tank 20. Once all of the high temperature, combustible residue has been transferred from the reactor 3 to the residue storage tank 20, the power sources 1,6 are deactivated, the clutch 2 is disengaged which will disconnect the first power source 1 and the driver shaft 16, and the first tube 10 is retracted from the flange 5.

From the foregoing, it is believed that one of skill in the art will readily recognize and appreciate the novel advancement of this invention over the prior art and will understand that while the same has been described herein and associated with preferred illustrated embodiments thereof, the same is nevertheless susceptible to variation, modification and substitution of equivalents without departing from the spirit and scope of the invention which is intended to be unlimited by the foregoing except as may appear in the following appended claims.

What is claimed is:

1. A continuous residue discharging system comprising:
a first residue discharging system housed inside of a reactor;
a curved tube protruding through a wall of said reactor and having an outlet extending outward from said reactor;
a flange on said outlet connected to a first tube;
said first tube being connected to a second tube, said second tube further connected to a residue storage tank;
a second residue discharging system housed inside of said second tube;
wherein a closed residue discharging channel is formed between said first residue discharging system and said second residue discharging system.

2. The continuous residue discharging system of claim 1, wherein said first residue discharging system comprises a three shaft conveyor system.

3. The continuous residue discharging system of claim 2, wherein said three shaft conveyor system further comprises a driver shaft and a first and second driven shaft.

4. The continuous residue discharging system of claim 3, wherein said driver shaft and said first and second driven shafts are each supported by one or more sliding bearings.

5. The continuous residue discharging system of claim 3, wherein said driver shaft further comprises a spiral vane disposed thereon and said first and second driven shafts each further comprise a residue collecting vane disposed thereon.

6. The continuous residue discharging system of claim 3, wherein said driver shaft further comprises a driver gear intertwined with a first gear of said first driven shaft and a second gear of said second driven shaft whereby rotation of said driver shaft thereby results in synchronized rotation of said first and second driven shafts.

7. The continuous residue discharging system of claim 3, wherein a first power source, through a clutch, delivers power to said driver shaft thereby causing it to rotate.

8. The continuous residue discharging system of claim 2, wherein one of said three shafts extends from inside of said reactor to an inside of said curved tube.

9. The continuous residue discharging system of claim 1, wherein said first residue discharging system comprises any number of shafts.

10. The continuous residue discharging system of claim 1, wherein said first tube is retractable from said flange.

11. The continuous residue discharging system of claim 1, wherein said second tube is steel and has a diameter of about 325 mm.

12. The continuous residue discharging system of claim 1, wherein said second residue discharging system comprises a single driver shaft conveyor system.

13. The continuous residue discharging system of claim 12, wherein said single driver shaft is supported by one or more sliding bearings.

14. The continuous residue discharging system of claim 12, wherein said single driver shaft further comprises a spiral vane disposed thereon.

15. The continuous residue discharging system of claim 1, wherein said second residue discharging system comprises any number of shafts.

16. The continuous residue discharging system of claim 12, wherein a second power source delivers power to said single driver shaft thereby causing it to rotate.

17. A method of discharging residue comprising the steps of:
providing a reactor with a first residue discharging system housed therein, said first residue discharging system comprising at least one driver shaft, said driver shaft comprising a spiral vane disposed thereon;
providing a curved tube protruding through a wall of said reactor and having an outlet extending outward from said reactor;
connecting said outlet to a first tube through a flange;
connecting said first tube to a second tube, said second tube further connected to a residue storage tank;
providing a second residue discharging system housed inside of said second tube, wherein a closed residue discharging channel is formed between said first residue discharging system and said second residue discharging system and wherein said second residue discharging system comprises at least a single driver shaft including a spiral vane disposed thereon;
activating a first power source which thereby, through a clutch, transfers power to said driver shaft thereby causing it to rotate;
activating a second power source which thereby transfers power to said single driver shaft causing it to rotate;
conveying residue by rotation of said driver shaft and spiral vane from said reactor to said curved tube, through said first tube, and to said second tube;
conveying said residue by rotation of said single driver shaft and spiral vane from said second tube to said residue storage tank.

18. The method of claim 17, further comprising the step of:
providing a first and second driven shaft, each comprising a residue collecting vane disposed thereon, as part of said first residue discharging system;
intertwining a driver gear of said driver shaft with a first gear of said first driven shaft and a second gear of said second driven shaft; and
transferring power from said first power source, through said clutch, to said driver shaft, thereby causing said driver shaft to rotate, and through the intertwined driver, first and second gears, causing said first and second driven shafts to rotate.

19. The method of claim 18, further comprising the step of:
beginning the method immediately after the reactor is shut down while the reactor is still near operating temperature.

20. A continuous residue discharging system kit comprising:
a reactor;
a first residue discharging system;
a curved tube having an outlet with a flange thereon;
a first tube;
a second tube;
a second residue discharging system; and
a residue storage tank.
